(19) United States
(12) Patent Application Publication
(10) Pub. No.: US 2011/0010736 A1
(43) Pub. Date: Jan. 13, 2011

(54) MULTIPURPOSE TV CONVERTER SYSTEM

(76) Inventors: Jong Hae Kim, Seoul (KR); Kyoung Ja Han, Seoul (KR); Michael Jitae Kim, Northridge, CA (US); Tommy Y. Kim, Palos Verdes, CA (US)

Correspondence Address: BROOKS KUSHMAN P.C., 1000 TOWN CENTER, TWENTY-SECOND FLOOR, SOUTHFIELD, MI, 48075, US

(21) Appl. No.: 12/919,180

(22) PCT Filed: Feb. 25, 2009
(86) PCT No.: PCT/KR2009/000878

§ 371 Date: Aug. 24, 2010

(30) Foreign Application Priority Data
Feb. 27, 2008 (KR) 10-2008-001 7587

(51) Int. Cl. H04N 7/173; H04N 5/445; H04N 7/025; H04N 5/14

(52) U.S. Cl. 725/33; 348/571; 725/59; 725/110; 348/552; 348/E05.062

(57) ABSTRACT

The present invention relates to an improved TV converter system for changing digital TV signal to analog and/or having multipurpose capabilities that the host computer of the TV broadcast station remotely controls the TV converter system according to the address and transmits a national emergency disaster warning signal, a digital file of printing contents such as newspaper, commercial catalogues or books, and contents of VOD to the specific TV converters by its' address.

It also provides the technology for high speed wireless internet service with the TV converter by its bidirectional data communications system which comprises the downward signal with a digital TV broadcasting signal through the TV converter and upward signal with data transmission system of subscriber's mobile phone network system.

### CROSS REFERENCE TO RELATED APPLICATION

This invention is a continuation-in-part of GB2376580B and PCT/KR2000/001165 on Oct. 18, 2000 (Addressable Television Broadcasting System) and patent application KR 10-2008-0017587 A (Multipurpose TV Converter System) on Feb. 27, 2008.

### FIELD OF THE INVENTION

The present invention relates to an improved TV converter system for changing digital TV signal to analog signal for analog TV holders, and/or having multipurpose capabilities by configuring a detachable address designating means on each TV converter with a removable IC module for addressable television broadcasting capability, so that the host computer of the TV broadcast station remotely controls each TV converter system according to the address and transmits a national emergency disaster warning signal, a digital file of printing contents such as newspapers, commercial catalogues or books, and contents of VOD (Video On- Demand) to the specific TV converters. It also provides the technology for wireless internet service with the bidirectional data communications system which comprises the downward signal with a digital TV broadcasting signal by using the TV converter and upward signal with data communication system of the existing mobile phone network.

### BACKGROUND OF THE INVENTION

When every country changes the existing analog TV broadcasting system to the digital television broadcasting system, the analog television holders cannot pick up the TV broadcast in signal. Thus, each country defrays expense for providing the TV converter which receives the digital television broadcast signal and changes to the analog television broadcast signal for the analog TV set holders.

However, the said TV converter is simply changing the signal from digital to analog only, after the completion of the change of TV set, hundreds of millions of TV converters will become a mass production of industrial waste.

The prior TV broadcasting station cannot remotely control the subscriber's TV set, and it was impossible for the broadcasting station to alert the viewer who have switched off the television set and are asleep when an emergency arises, since the prior systems do not have a remote control means to turn-on the TV set, tune to the channel where the emergency information is being broadcasting and turn-up the volume loud enough to wake up the viewers who are in bed.

In addition, the prior art broadcasting station were unable to televise a special program to a specific mass. Group broadcastings, as for example, preaching a religious sermon to a specific religious group, a broadcast for families of the employees of a company, a high security broadcasting program for soldiers or policemen and similar professions, and educational related programs for specific students were impossible to be provided.

Though all of the television broadcasting system such as the network television, satellite and cable television may be digitalized and the superior means to transmit the digital data of video, audio, images, letters, and graphics by its digital network, it is still not possible to provide e-mail service, e-newspaper delivery service or internet service due to the lack of a technology to deliver a specific broadcasting signal directly to a specified individual.

One aspect of the present newspaper industry is that each press company carries the burden of relying heavily on manpower to deliver the printed newspaper to the readers. Another exiting problem is the increasing labor costs, thus increasing the costs of subscription of newspaper as well as the difficulty of hiring employees to do such physical labor. Yet another problem is the delivery of newspapers on timely basis to subscribers residing at remote areas or abroad. Also, the increasing consumption of paper for printing newspaper causes worldwide environmental crisis. To overcome the limitations in the prior art described above, the press company had developed a system to provide news through the internet. But readers could access the news only through the PC monitor, and would be unable to scan the original newspaper through the TV sets as they read the printed original journal.

### THE BRIEF SUMMARY OF THE INVENTION

The present invention is to provide the technology to add multipurpose capabilities on the TV converter for the national emergency warning, the printed contents delivery of newspaper or e-book, the parental guided service and the internet services by configuring address means of each TV converter for addressable broadcasting capability.

By the present invention, the host computer of the TV broadcast station remotely controls the subscriber's converter with the signal of destination address and instruction inserted into the digital television broadcast signal. So that, the computer of the national emergency and disaster warning system can deliver their warning signal or message to specific receivers with the TV converter according to its' address and controlling receiver's TV set by power-on, changing channel, volume-up even receiver are sleeping.

And also, it provides the online delivery system of the newspaper or the contents of e-book with the TV converter. To assume network, satellite or cable TV broadcasting station using addressable broadcasting television techniques, the newspaper may be compressed to digital data, where it can be transmitted and stored to the subscriber's terminal of the designated subscribers, then there is a need to develop a subscription service where one may subscribe electronically to a variety of newspapers through the television monitor, or any of electronic display means and pay the arranged subscription fees.

It would then be possible to view newspaper with monitor from a variety of subscribed newspaper, and an important and/or necessary article may be printed out or stored as digital data.

Moreover, the TV converter system is implementing VOD and internet service in terms of the configuration of the economic bidirectional data communications network utilizing on the host computer of the TV broadcast station to intermediary with the downward signal with the digital TV broadcasting signal and the up-ward signal with the mobile communication network.

### THE BRIEF DESCRIPTION OF THE DRAWINGS

Overcoming the limitations faced from the previous technology, hereinafter, the system configuration of the present invention and the functional effect for solving the above-described subject referring to the figures attached are illustrated.

FIG. 1 is a block diagram of the TV converter system of the present invention.

FIG. 2 is a block diagram of a method and system for implementing the national emergency disaster broadcast in terms of the TV converter system of the present invention.

FIG. 3 is a block diagram of electronic newspaper online delivering method and system of the present invention.

FIG. 4 is a block diagram of a method and system providing VOD and wireless internet service to the TV converter system of the present invention.

### [DETAILED DESCRIPTION OF THE INVENTION]

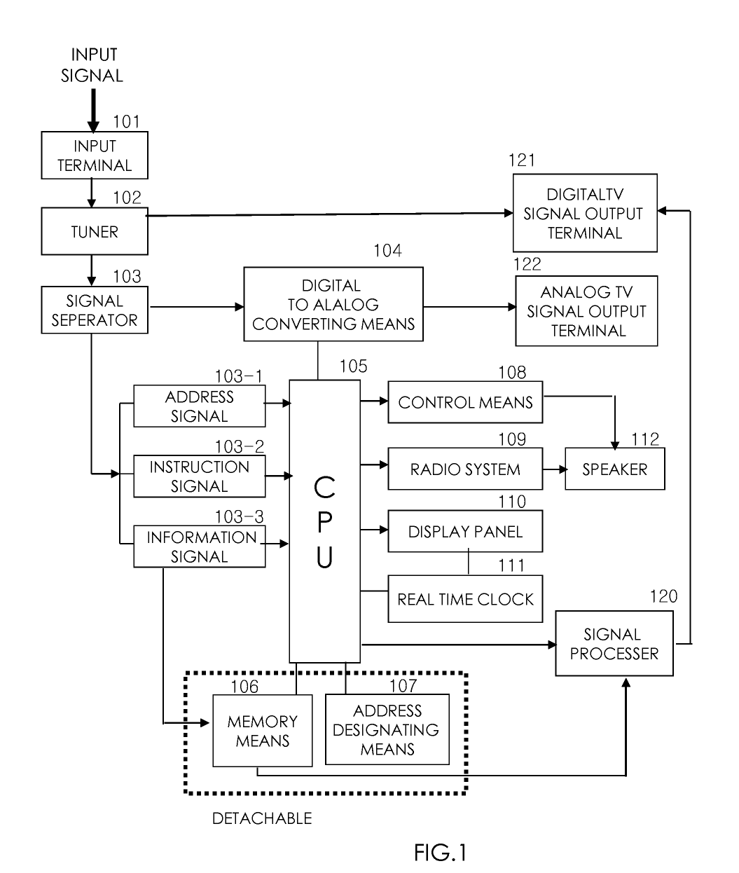

Referring to attached illustrates in FIG. 1, the conventional TV converter system is comprising tuner means (102) for selecting the digital TV signal inputted with the input terminal (101), a converting means (104) for changing the tuned digital television broadcast signal into the analog television signal, and output terminal means (122) for outputting the converted analog television broadcast signal to the analog television set.

In addition to the above system, the TV converter of the present invention is comprising a digital television output terminal means (121) for outputting the digital television signal tuned by the tuner (102), a removable address assigning means (107) for specifying the address of converter, a signal separation means (103) for separating data signal (103-3) inserted in the digital television broadcasting signal according to its address signal (103-1) and instruction signal (103-2), a detachable memory means (106) for storing the data separated from the signal separation means (103), and a CPU (105) having software programmed for fulfill the above functions.

In the system with which the present invention is used, the said converter system has multifunctional capabilities not only converting the digital TV signal to analog but also providing digital TV broadcasting signal after tuned for a digital TV set and delivering data file to the specified address designated converter for national emergency warning, e-newspaper, e-book, VOD (Video On Demand) operation and Internet services.

In the configuration, the removable address assignment means (107) is comprising an IC module such as an IC card, SIM (Subscriber Identification Module), USIM (Universal Subscriber Identification Module), UIM (User Information Module), or

UICC (Universal IC Card), and it makes convenience for the subscribers by its attachability /detachability to the converter system. Moreover, it can be comprised a memory means (106) with the removable USB (Universal Serial Bus) driver memory means for storing the data of e-book, e- catalogue, or e-newspaper to display on not only TV monitor but also other display panels such as e-paper, iPod, laptops, PDAs or Kindle and other e-book devices, and for easy up-grading the capability of memory.

Moreover, in the converter system, if the radio system (109) is comprised for the national emergency disaster broadcast purpose, the host computer of the emergency warning organization can remotely control the function of the radio by power-on, changing channel and volume-up by the instruction signal (103-2) inserted in the digital TV signal.

The emergency signal system can repetitively oscillate the voice message signal if it's configuring the warning control means (108) with the voice chip in which the siren signal or the alerting message is memorized for the emergency alarm classification in order to alarm the specific emergency signal with the speaker unit (112) of the radio system.

Moreover, the converter system can be equipped with an optional LED display means (110) for displaying a warning message by scrolling characters on the display panel under the instruction signal (103-2) inserted in the digital TV signal.

Further, a supplement of real time clock (111) to the CPU (105), the function of watch is implemented in terms of the LED display means (110) for displaying date and time on the display panel of the TV converter and designating time and date onto the each storing data.

The system with which the present invention is used, the system control means of the broadcasting facility calls the subscriber with the TV converter by the individual address of the IC module with the instruction data signal of the broadcasting signal, and designating a group address according to the purpose of usage such as an emergency alert broadcasting by group, an e-newspaper delivery broadcasting by brand, a parental guide broadcasting by age, an e-mail as well as internet data delivery by group and an educational broadcasting by class.

In addition, with the addressable TV broadcasting system above, when the broadcasting station broadcasts programs that are prohibited to children and the subscriber requests such programs not to be run on their personal TV sets, the broadcasting station may then insert an instruction data onto a data channel of the broadcasting program signal, and broadcast the program with the address code of the receiver to the subscriber's converter unit to control subscriber's TV to skip the prohibited programs that are being televised.

At this time, if the subscriber transmits the data to prohibit the broadcasting of a specified rated program to the host computer of the broadcasting station, the host computer will adjust the common group address of similar rate, endowing the necessary group address to control the unit of the subscriber, which allows the control of common addresses as subscribers may request to the host computer of the broadcasting station the prohibition of a specified class programs, this provides the improved system on the previous V-chip.

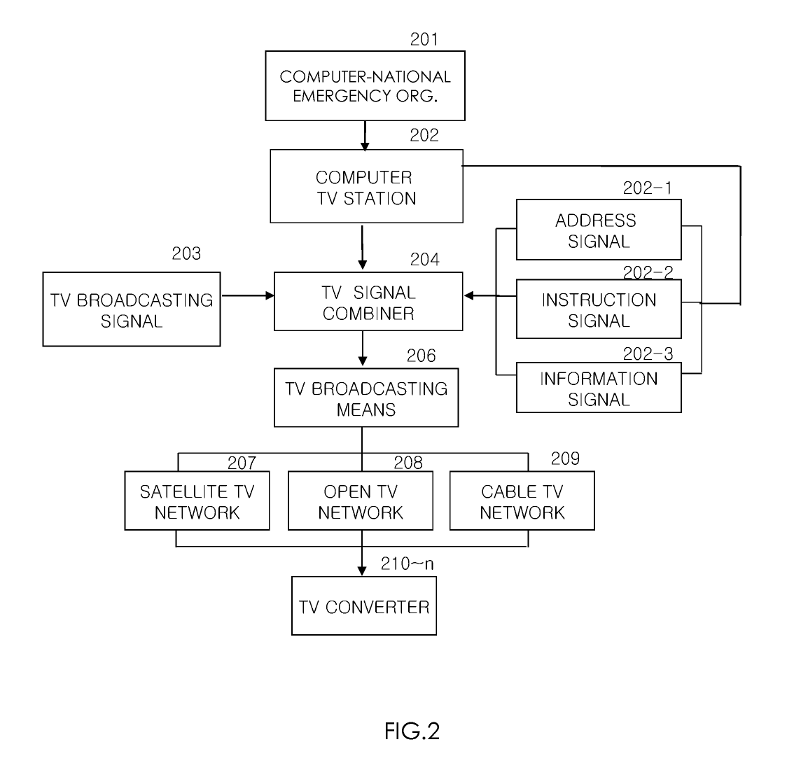

FIG. 2 is a block diagram for method and system implementing the national emergency disaster broadcasting by using the present TV converter system. According to FIG. 2, if the national emergency disaster signal in which the destination address is specified in the computer system (201) of the national emergency disaster system is transmitted to the computer (202) of the TV broadcast station, the computer (202) combines the emergency signal into the data channel of the television broadcasting signal with TV signal combiner (204) by inserting the address signal (202-1), instruction signal (202-2) and information signal (202-3) and broadcasts the signal to the address designated TV converters through existing open television broadcasting network (208), a satellite television broadcasting network (207), or a cable television broadcasting network (209) by the TV broadcasting means (206).

Accordingly, the CPU of the TV converter turns the TV power-on, tunes TV channel to the national emergency channel and volumes-up according to the instruction signal (202-2) so that the subscribers are forcedly receiving the warning signal through TV even they are sleeping.

Moreover, when configuring the radio receiver in addition to the CPU of the TV converter, the computer system (201) of the national emergency disaster system remotely control the radio power-on, tuning to the emergency channel and tunes the volume-up for listening the national emergency disaster radio broadcasting even the subscribers are in full sleep.

Moreover, when configuring a display panel means in addition to the above system, the CPU of the TV converter displays the emergency message signal according to the instruction signal (202-2) and the information signal (202-3) on the display panel by scrolling the message characters on the monitor panel. Therefore, the present invention provides the useful technology that the computer system of the national emergency disaster system remotely controls the TV converter of each subscriber and transmits the national emergency disaster broadcast or message to the specified address designated receivers by individual or a group of occupation or area.

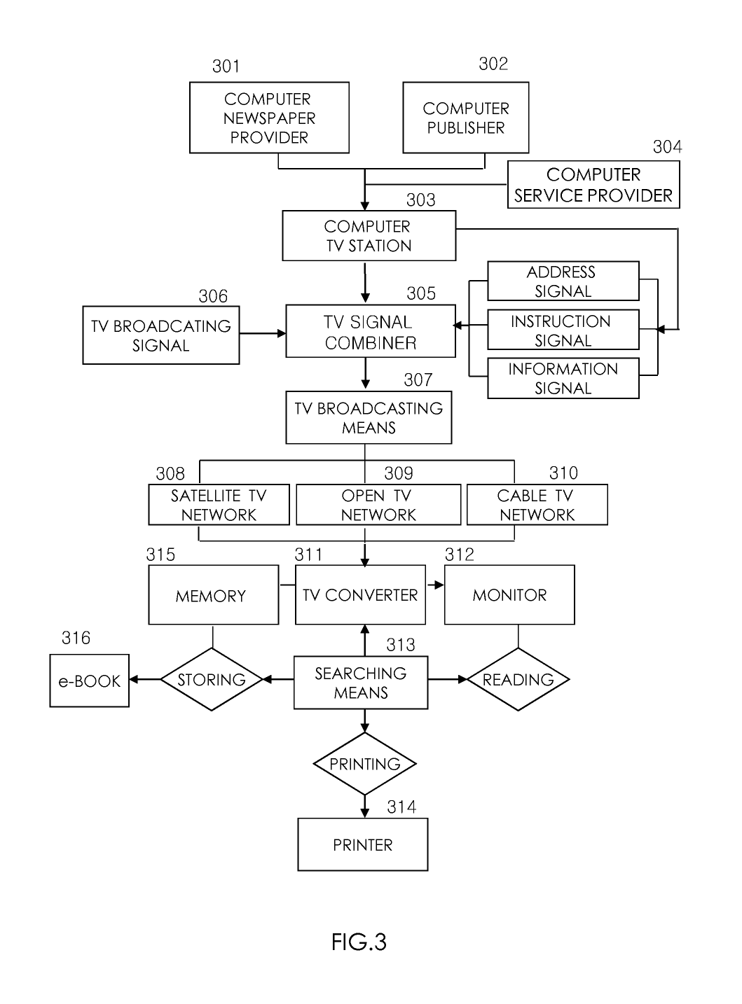

FIG. 3 is a block diagram of method and system for the online publication delivery system which transmits newspaper or publication with the form of digital printing file to the subscribers with the TV converter system of the present invention. Referring FIG. 3, the newspaper online delivery system comprises the step of, configuring a digital signal output terminal for transmitting the newspaper signal to the digital monitor, configuring an address designating means of the TV converter (311) with the IC module such as SIM, USIM, UIM, UICC or IC card in order to set up the address of converter, configuring a memory means such as an IC module or a detachable USB flash driver to the TV converter for storing data transmitted, transmitting the electronic newspaper printing file by a SSP (Supplementary Service Provider) of the electronic newspaper that receives newspaper printing files from one or more newspaper companies and designating the subscriber's address and transmits to the host computer (303) of the TV broadcast station, transmitting the electronic newspaper data file to the TV converter of the subscribers by combining the file into the data channel of the TV broadcasting signal by the TV station's host computer system, separating the electronic newspaper data file from the TV broadcasting signal according to its' address and storing data file of the separated newspaper in the memory means (315) of the TV converter, and displaying the newspaper on the TV monitor by controlling with a remote-control of the TV converter for searching, enlarging articles, printing or storing the certain articles for scraping couple to the control of the CPU of the TV converter.

When the specific article being pasted into e-scrapbook for preserving, the subscribers control the CPU and the specific article is classified by contents to be memorized and stored in the memory means (315), it makes a database of newspaper for subscribers.

At this time, if a real-time clock means is added to the CPU, it specifies the storage date of each article in the memory means.

Besides, according to the program of the software which is set up in the CPU of the TV converter, the memory means (315) always memorizes a certain number of latest newspaper files according to the memory capacity, the memory means (315) successively saves memory data of the certain volume of latest received files by erasing the oldest files automatically.

Moreover, according to the present invention, the CPU of the TV converter controls the memory means to store a plurality of newspapers by a newspaper brand according to the subscriber's choice. Also it could be programmed to store into USB driver so that the memory capacity is arbitrarily increased and it makes the subscribers separate the USB from the TV converter and attach to e-book or other monitor system for displaying instead of the TV monitor. It enables the same function as of the TV converter for searching, enlarging, printing or storing the articles that viewers select according to a software programmed of the CPU of the monitor system such as e-book e-newspaper or a similar e-display system. With the system, the electronic commercial transaction such as a catalogue online sale, delivery e-books or e-magazine can be implemented instead of the newspaper. When system is utilized for the education, a file of all kinds of the textbooks or the reference book can be transmitted to student's e-book by the TV network instead of internet. Moreover, the video file of movie or the music can be transmitted to USB of the address-designated TV converter and makes the commercial transaction of the ON-DEMAND type of business by TV network.

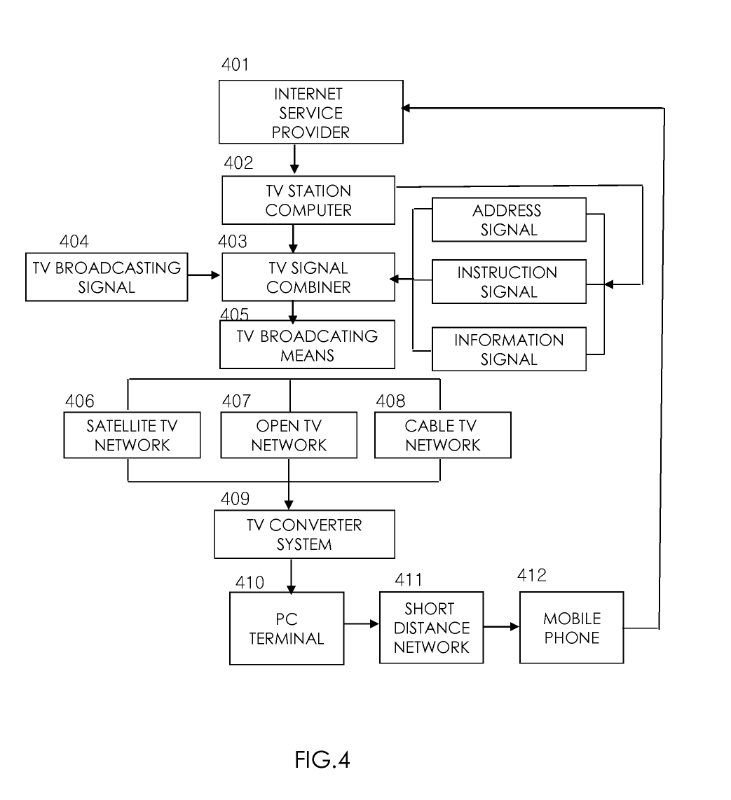

Particularly, the present invention provides the most cheap data delivery system by the removable USB driver stick which removes from the TV converter and attach to subscribers cellular phone, PDA, e-book or other monitor systems for displaying. FIG. 4 is a block diagram of method for the internet service system using the TV converter of the present invention. The addressing apparatus of the system comprises the IC module such as SIM, USIM, UIM, UICC or IC card as of FIG. 1 of the TV converter (409) in order to appoint the address of converter.

The internet service system utilizing the TV converters is comprising the step of, configuring a short distance wireless communications means such as a Bluetooth, ZigBee, Wibree, UWB, or NFC. between the TV converter system, a subscribers personal computer and a mobile phone, configuring a down-stream signal with TV broadcasting signal that the host computer (402) of the TV broadcast station received the internet data signal from the internet service provider (401), designating the receivers address by combining to data channel the TV data broadcasting signal for transmitting through TV broadcasting network, configuring an up-stream signal with a data signal of the subscriber's mobile phone system, and communicating the down- stream signal and the up-stream signal between the TV converter, subscriber's personal computer system and the subscriber's mobile phone for internet service by the short distance wireless communication means. With the above system, it will be the same result even the short distance communication means comprises a cable connection with USB of the TV converter system and the mobile phone system instead of the wireless means.

Thus, it is providing a high speed wireless communication technology for internet service comprising a down-stream data signal by means of a data channel of the broadcasting signal or a digital broadcasting signal itself, and an up-steam data signal by means of a wireless mobile phone network using the host computer of the broadcasting station for relaying the communication signals of the up-stream signal and the down-steam signal between the internet server and personal computers.

The foregoing description of the preferred embodiment of the invention has been presented for the purpose of illustration and description. It is not intended to be exhaustive or to limit the invention to the precise form disclosed. Many modifications and variations are possible in light of the above teaching of modify the TV converter to any television terminal. It is intended that the scope of the invention be limited not with this detailed description, but rather by the claims appended hereto.

### INDUSTRIAL APPLICABILITY

(1) The present invention provide the technology for remote controlling each subscriber's TV converter by the host computer of the TV broadcasting station so that it provides the most effective national emergency disaster broadcast system for individual or group target even the subscribers are sleeping, by remotely controlling the subscriber's TV converter for power ON/OFF, tuning channel, volume up/down of the subscriber's TV set or radio system of the converter.

Moreover, it provides the useful warning message delivery means comprising the display panel in the TV converter for delivering the text message which specifies to the receiver's individual ID or the group ID with the computer of television broadcasting network.

(2) The online electronics data file delivery system of the newspaper using the TV converter is provided. The printing file of newspaper is transmitted to subscribers by using the television broadcasting network instead of internet, it provides the most cheap electronic newspaper delivery system world-wide by satellite TV network.

(3) The electronic delivery system of the publication utilizing the TV converter is provided. Subscribers can purchase the file of the necessary magazine or publication through the TV converter instead of internet. Moreover, after the file of textbook or the reference book is delivered to each school students by using the TV converter, this data file can be moved to e-Book by the USB and it provides the useful technology for the students free from the book bag which is heavy to carry.

(4) The file of the commercial catalog book using the TV converter can be transmitted and it can use as the new electronic catalog commerce method. It reduces the heavy cost for catalogue printing and mailing to individual, and provides technology to establish a new online catalogue sale business through subscribers TV set.

(5) The present invention provides the ON-DEMAND system for transaction files including the music video or movie etc. through TV network. The cost of data delivery with the invention is the cheapest among the existing media system and it makes a new business replacing the existing video and music stores.

(6) The present invention also provides the technology to make cheapest wireless internet service utilizing the TV converter and the personal mobile phone. Since the data transaction cost by the mobile phone is extremely high and character data transmission cost of the mobile phone system is relate low, the present invention is applicable to make a new wireless internet service network utilizing the TV converter and the subscriber's mobile phone.

What is claimed:

1. A TV converter system having multipurpose capabilities comprising,
(a) means for outputting analog TV broadcasting signal to TV set after converting digital television signal to analog TV signal and means for outputting digital TV broadcasting signal after tuning the digital television broadcast signal received,
(b) means for designating address of the TV converter by inserting a removable IC module selected from the group consisting of SIM, UIM, UICC, USIM and IC card.
(c) means for separating an instruction signal and a data signal that the host computer of the TV broadcasting station inserts into a data channel of the digital TV signal with the address signal of each receiver,
(d) a detachable memory means for memorizing the data signal separated by the separating means, and
(e) a CPU for controlling the above means with a software programmed in order to control the function of the TV converter as well as memorizing the data signal separated from the TV broadcasting signal, and controlling the TV converter by its address according to the instruction signal from the host computer of the TV broadcasting station.

2. The system of claim 1, wherein data signal separated from the TV broadcasting signal memorizing onto a memory means configured in the converter system coupled to the CPU instead of the detachable memory means.

3. The system of claim 1, wherein the detachable memory means further comprising an USB memory module for detachable operation to other monitors system.

4. The system of claim 1, wherein the data signal is comprising a data file selected from the group consisting of a newspaper, a brochure, a commercial catalogue, a publication and a book, in order to displaying the printing data on a monitor with a controller for enlarging, reading, storing, or printing the data of the specific articles selected by the subscriber's choice.

5. The system of claim 1, further comprising a radio receiver so that the host computer of the TV broadcast station controls the function of the radio receiver's power ON/Oft, tuning channel and volume UP/DOWN for national emergency disaster radio broadcasting to be received according to the instruction signal inserted onto the TV broadcasting signal.

6. The system of claim 1, further comprising LED display panel means for displaying message data by characters scrolling on the LED display panel coupled to the CPU according to the address-designated instruction signal inserted onto the TV broadcasting signal.

7. The system of claim 6, further comprising a real-time-clock means for displaying date and time on the LED display panel of the converter system and designating time and data onto the storing data.

8. A method for implementing the national emergency disaster TV broadcasting signal by utilizing a TV converter system which receives the digital TV television broadcasting signal comprising, the step of (a) configuring a detachable address assigning means in order to set the address of the TV converter system with means selected from the group consisting SIM, USIM, UIM, UICC and IC module,
(b) transmitting the national emergency disaster TV broadcasting signal by inserting 17 onto the TV broadcasting signal according to the address designated, and
(c) controlling the TV converter system's power-on, tuning the TV set to the national emergency disaster broadcasting channel and volume-up, coupled to CPU of converter system, according to the remote control signal from the host computer of the TV broadcasting station.

9. A method for delivering a newspaper to a plurality of specific subscribers by the digital data file format utilizing a TV converter system which receives the digital television broadcasting signal comprising the step of,
(a) configuring an output terminal means for transmitting the digital television signal to a digital TV set after tuning,
(b) assigning an address of the TV converter system with means selected from the group consisting of SIM, USIM, UIM, UICC and IC module coupled to CPU of the TV converter system,
(c) configuring removable memory means with USB device connecting, coupled to CPU of the TV converter system,
(d) transmitting newspaper printing files that the host computer of electronic newspaper service provider received from one or more contracted newspaper companies, inserting address data of subscriber and transmitting to the host computer of the TV broadcasting station.
(e) transmitting the newspaper file data by inserting onto the data channel of TV broadcasting signal to the subscriber's TV converter system according to the address by means of a head end of the TV broadcast station,
(f) storing the digital data of newspaper in the memory means after separating the 18 data of newspaper from the TV broadcasting signal which designated the address of the subscribers, and
(g) displaying the newspaper which stored in the memory means on monitor means connected with the output terminal of the TV converter or attaching the USB device, with a searching means for searching articles on the monitor for reading, enlarging, printing or storing according to the software programmed of the CPU of the TV converter or the monitor system.

10. The system of claim 9, further comprising the step for assigning a group address according to the newspaper and delivering the file of newspaper with the group address which inserts into the TV broadcast signal.

11. The system of claim 9, the contents of file further comprising contents selected from the group consisting of a magazine, a commercial catalogue, a publication and a book instead of the newspaper for delivering the file to the TV converter.

12. The system of claim 9, the contents of file is further comprising a digital file of video on demand instead of the newspaper.

13. A method for controlling a parental guided program broadcasting utilizing a TV converter system comprising,
(a) a step for configuring a address designating means into the TV converter with a means selected from the group consisting of SIM, USIM, UIM, UICC, and IC module coupled to a CPU of the TV converter system,
(b) a step for broadcasting the parental guided program with an instruction signal inserted onto the data channel of the program signal to skip the channel according to the address, and 19
(c) a step for controlling the converter system to skip the parental guided program according to the instruction signal inserted onto the program.

14. A method for providing bi-directional data communication for wireless internet service by using a TV converter comprising,
(a) a step for designating addressing of the TV converter with attachable means selected from the group consisting of SIM, USIM, UIM, UICC and IC module,
(b) a step for configuring a short distance wireless communication means between the TV converter, a mobile phone of subscriber and a subscriber's PC,
(c) a step for configuring a wireless down-stream data transmission network from a computer system of internet service provider to the TV converter by means of a data transmission system of the digital TV broadcasting system with the subscriber's address designated to the TV converter,
(d) a step for configuring a wireless network for transmitting up-stream data signal from the subscriber's PC by means of a data transmission system of the subscriber's mobile phone network system, and
(e) a step for receiving the down-stream internet data signal from the computer system of the internet service provider to the subscriber's PC with a wire or wireless short distance communication means between the PC and the TV converter and transmitting the up-stream internet data signal with the subscriber's mobile phone network to the computer system of the internet service provider.
